(19) United States
(12) Patent Application Publication
(10) Pub. No.: US 2026/0148719 A1
(43) Pub. Date: May 28, 2026

(54) ELECTRONIC DEVICE, TIMBRE CHANGE METHOD, AND RECORDING MEDIUM

(71) Applicant: Roland Corporation, Shizuoka (JP)

(72) Inventors: Takashi Nishimura, Hamamatsu (JP); Tomoyuki TAMURA, Hamamatsu (JP)

(73) Assignee: Roland Corporation, Shizuoka (JP)

(21) Appl. No.: 19/326,778

(22) Filed: Sep. 12, 2025

(30) Foreign Application Priority Data
Nov. 26, 2024 (JP) 2024-205174

(51) Int. Cl. G10H 1/057; G10H 1/14

(52) U.S. Cl. CPC G10H 1/057; G10H 1/14; G10H 2220/221; G10H 2250/025; G10H 2250/625

(57) ABSTRACT

An electronic device includes a plurality of operators and outputs a musical tone. The electronic device includes a hardware processor configured to deform a timbre waveform, which is a basic waveform representing a timbre of the musical tone being output, based on a setting value according to an operation on each of the operators; generate the musical tone based on the deformed timbre waveform and pitch information that is input; and output the generated musical tone.

### CROSS-REFERENCE TO RELATED APPLICATION

This application claims the priority benefit of Japanese application serial no. 2024-205174, filed on November 26, 2024. The entirety of the above-mentioned patent application is hereby incorporated by reference herein and made a part of this specification.

### TECHNICAL FIELD

The disclosure relates to an electronic device, a timbre change method, and a recording medium.

### BACKGROUND ART

Patent Document 1 (Japanese Patent Application Laid-Open No. 2023-176066) discloses an electronic musical instrument that can switch the timbre of a musical tone being output in real time according to instructions from a user H. Specifically, the user H selects a desired timbre from multiple timbres by operating a setting key 4 during performance of the user H, and the selected timbre is applied to the musical tone being output.

Although in Patent Document 1 the type of timbre applied during output of a musical tone is switched, the timbre aspects such as texture and brightness of the timbre are fixed to those preset for each timbre. This leads to a problem that the user H cannot freely change the timbre aspects applied to the musical tone during output of the musical tone.

The disclosure provides an electronic device, a timbre change method, and a timbre change program that are capable of changing the timbre aspects applied to a musical tone during output of the musical tone.

### SUMMARY

An electronic device according to the disclosure includes a plurality of operators and outputs a musical tone, and the electronic device includes a hardware processor configured to deform a timbre waveform, which is a basic waveform representing a timbre of the musical tone being output, based on a setting value according to an operation on each of the operators; generate the musical tone based on the deformed timbre waveform and pitch information that is input; and output the generated musical tone.

A timbre change method according to the disclosure is a method executed by an electronic device including a plurality of operators, and the timbre change method includes: deforming a timbre waveform, which is a basic waveform representing a timbre of a musical tone being output, based on a setting value according to an operation on each of the operators; generating the musical tone based on the timbre waveform deformed and pitch information that is input; and outputting the musical tone generated.

Further, a non-transitory computer-readable recording medium records a timbre change program according to the disclosure, which is a program that causes a computer including a plurality of operators to execute processing for changing a timbre of a musical tone being output, and the timbre change program causes the computer to execute: deforming a timbre waveform, which is a basic waveform representing the timbre of the musical tone being output, based on a setting value according to an operation on each of the operators; generating the musical tone based on the timbre waveform deformed and pitch information that is input; and outputting the musical tone generated.

### BRIEF DESCRIPTION OF THE DRAWINGS

FIG. 1 is a diagram representing the external appearance of the synthesizer.

FIG. 2A is a diagram illustrating the control keys used for creating a timbre waveform, and

FIG. 2B is a diagram representing the timbre waveform based on the press position of the control key.

FIG. 3 is a block diagram showing the electrical configuration of the synthesizer.

FIG. 4 is a functional block diagram of the synthesizer.

FIG. 5A is a flowchart of the main processing,

FIG. 5B is a flowchart of the smoothing processing, and

FIG. 5C is a flowchart of the DC removal processing.

FIG. 6A is a flowchart of the sound generation processing,

FIG. 6B is a flowchart of the pitch control processing, and

FIG. 6C is a diagram illustrating the musical tone generation processing.

FIG. 7A is a diagram illustrating the keys used for creating a timbre waveform in the second embodiment,

FIG. 7B is a diagram representing the element waveform of the fundamental tone based on the press position of the control key in the second embodiment,

FIG. 7C is a diagram representing the element waveform of the third harmonic based on the press position of the control key in the second embodiment,

FIG. 7D is a diagram representing the element waveform of the fifth harmonic based on the press position of the control key in the second embodiment,

FIG. 7E is a diagram representing the element waveform of the sixth harmonic based on the press position of the control key in the second embodiment,

and FIG. 7F is a diagram representing the element waveform of the seventh harmonic based on the press position of the control key in the second embodiment.

FIG. 8A is a diagram illustrating the timbre waveform in the second embodiment, and

FIG. 8B is a diagram illustrating the musical tone generation processing in the second embodiment.

FIG. 9A is a flowchart of the main processing in the third embodiment,

FIG. 9B is a diagram representing the interpolated press position of each control key in the case of all the control keys being released, and

FIG. 9C is a diagram representing the interpolated press position of each control key in the case of one of the control keys being pressed in the third embodiment.

FIG. 10A is a diagram representing the interpolated press position of each control key in the case of another one of the control keys being pressed in the third embodiment, and

FIG. 10B is a diagram representing the interpolated press position of each control key in the case of two of the control keys being pressed in the third embodiment.

### DESCRIPTION OF THE EMBODIMENTS

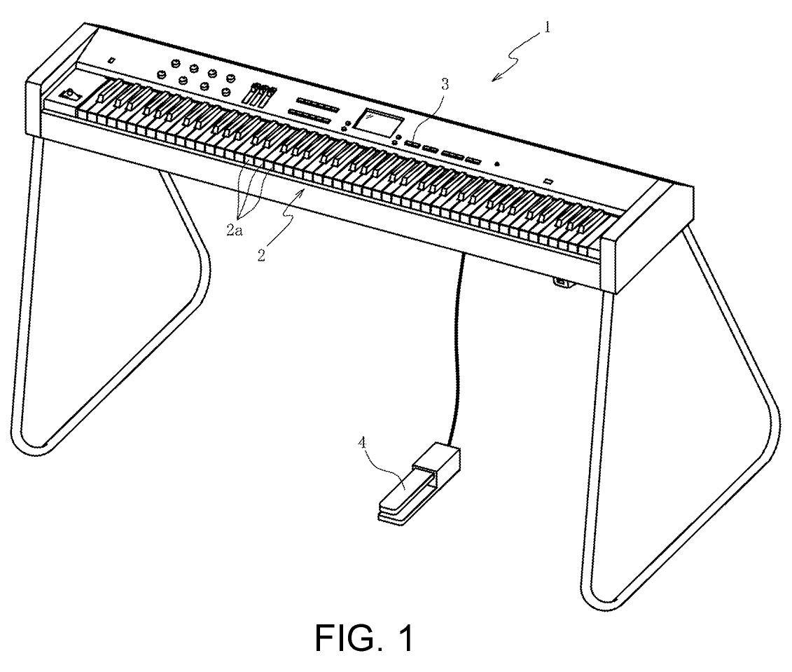

Hereinafter, exemplary embodiments will be described with reference to the accompanying drawings. The overview of a synthesizer 1 of the present embodiment will be described with reference to FIG. 1. FIG. 1 is a diagram representing the external appearance of the synthesizer 1.

The synthesizer 1 is an electronic musical instrument (electronic device) that mixes musical tones based on performance operations of a user H, predetermined accompaniment sounds, etc., and outputs (emits) the same. The synthesizer 1 is mainly provided with a keyboard 2, setting keys 3 for inputting various settings from the user H, and a pedal 4.

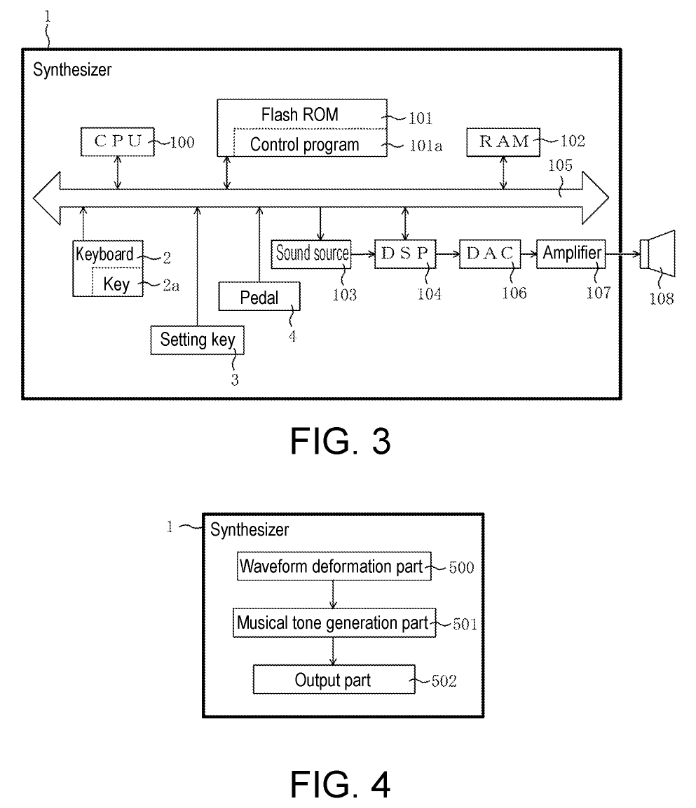

The keyboard 2 is an input device for acquiring performance information from the performance of the user H. Multiple keys 2a are arranged on the keyboard 2, and performance information corresponding to press/release operations (that is, performance operations) of the keys 2a performed by the user H is output to a CPU 100 (see FIG. 3). The position of the key 2a in the up-down direction (that is, key press depth, hereinafter referred to as "press position of the key 2a") due to the press/release performance operations of the user H may be detected stepwise using multiple contact switches or the like, or may be detected continuously using continuous detection sensors or the like. The pedal 4 is a foot-operated operator (second operator), and on is input from the pedal 4 to the CPU 100 in the case of the user H stepping on the pedal 4, and off is input from the pedal 4 to the CPU 100 in the case of the user H releasing the pedal 4.

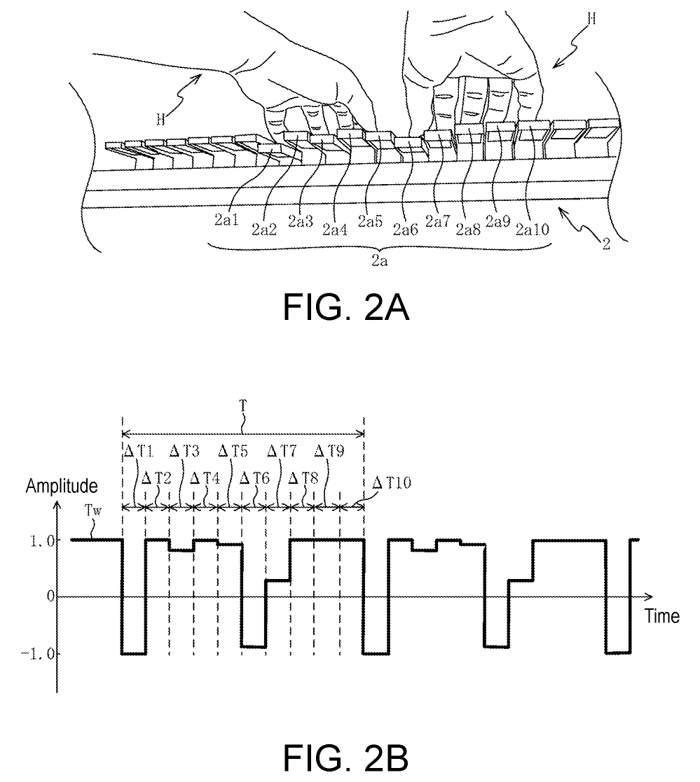

In the present embodiment, the timbre aspects are changed by changing a timbre waveform Tw, which is a waveform representing the timbre applied to the musical tone being generated, according to the press positions of control keys 2a1 to 2a10 among the keys 2a. The control keys 2a1 to 2a10, among the keys 2a, used for creating the timbre waveform Tw and creation of the timbre waveform Tw based on the press positions of these control keys 2a1 to 2a10 will be described with reference to FIG. 2A and FIG. 2B.

FIG. 2A is a diagram illustrating the control keys 2a1 to 2a10 used for creating the timbre waveform Tw. As the keys 2a used for creating the timbre waveform Tw, ten consecutive white keys among the keys 2a provided on the keyboard 2 are set as the control keys 2a1 to 2a10.

Among the ten consecutive white keys, the key 2a positioned at the leftmost is set as control key 2a1, the key 2a positioned to the right of the control key 2a1 is set as control key 2a2, and control keys 2a3 to 2a10 are set in order from the right of the control key 2a2 toward the right direction. The press position of each of the control keys 2a1 to 2a10 is acquired, and the timbre waveform Tw is created based on the acquired press position. Hereinafter, the control keys 2a1 to 2a10 are referred to as "control key(s) 2aX" unless particularly distinguished from each other.

Next, creation of the timbre waveform Tw based on the press position of the control key 2aX will be described with reference to FIG. 2B. FIG. 2B is a diagram representing the timbre waveform Tw based on the press position of the control key 2aX. As described above, the timbre waveform Tw is a waveform representing the timbre applied to the musical tone being generated by the synthesizer 1. The musical tone is generated and output based on the timbre waveform Tw and a pitch determined by an arpeggiator or sequencer which will be described later.

In the present embodiment, the timbre waveform Tw is itself an original waveform, and no underlying waveform exists as a premise. However, the disclosure is not limited thereto, and an underlying original waveform (for example, a sine wave) may be provided, and a waveform that is set (deformed) by the press position of the control key 2aX, like the above-described timbre waveform Tw, may be superimposed on or multiplied with the original waveform to create the timbre waveform Tw.

In the present embodiment, the shape of the waveform for one cycle in the timbre waveform Tw is set based on the press position of the control key 2aX, and is configured by repeating the set waveform. First, one cycle in the timbre waveform Tw is equally divided into divided periods ΔT1 to ΔT10. That is to say, the lengths of the divided periods ΔT1 to ΔT10 are each set to the same length. These divided periods ΔT1 to ΔT10 are respectively assigned to the control keys 2a1 to 2a10, and the amplitude of each of the divided periods ΔT1 to ΔT10 is set based on the press position of the corresponding one of the control keys 2a1 to 2a10.

Specifically, the amplitude of the divided period ΔT1 is set based on the press position of the control key 2a1, and the amplitude of the divided period ΔT2 is set based on the press position of the control key 2a2. Similarly, the amplitudes of the divided periods ΔT3 to ΔT10 are respectively set based on the press positions of the control keys 2a3 to 2a10.

In the present embodiment, the amplitude of the timbre waveform Tw is set with a minimum value of "-1.0" and a maximum value of "1.0." The higher the press position of the control keys 2a1 to 2a10, the larger the amplitude value set for the corresponding divided periods ΔT1 to ΔT10, and the lower the press position of the control keys 2a1 to 2a10, the smaller the amplitude value set for the corresponding divided periods ΔT1 to ΔT10.

Additionally, the amplitudes of the divided periods ΔT1 to ΔT10, which are set based on the press positions of the control keys 2a1 to 2a10, are maintained throughout each of the divided periods ΔT1 to ΔT10. For example, in the divided period ΔT1, the amplitude of -1.0 set according to the press position of the control key 2a1 is maintained from the start to the end of the divided period ΔT1.

Then, the shape of the waveform for one cycle is set by sequentially connecting the set amplitudes of the divided periods ΔT1 to ΔT10, and the timbre waveform Tw is created by repeating the set waveform. In the case where the press positions of the control keys 2a1 to 2a10 change after the timbre waveform Tw is created, the amplitudes of the divided periods ΔT1 to ΔT10 are reset accordingly and the timbre waveform Tw is updated. A musical tone is generated and output based on the created or updated timbre waveform Tw and a sound generation pitch which is the pitch determined by the arpeggiator or sequencer.

In this way, the shape of the timbre waveform Tw of the timbre applied to the musical tone being generated is set (deformed) according to the press positions on the control keys 2a1 to 2a10. This allows the user H to change the timbre aspects such as texture and brightness of the timbre applied to the musical tone during sound generation by pressing or releasing the control keys 2a1 to 2a10 during the generation of the musical tone.

Additionally, the control keys 2a1 to 2a10 for deforming the timbre waveform Tw include ten consecutive white keys among the keys 2a. The user H can easily and intuitively deform the timbre waveform Tw by performing simple operations of moving the control keys 2a1 to 2a10 up and down. Furthermore, since the ten white keys have the same shape and structure, the user H can easily grasp the differences in press positions among the control keys 2a1 to 2a10. This allows the press positions of the control keys 2a1 to 2a10 to be adjusted easily. In addition, with the ten control keys 2a1 to 2a10, the user H can deform the timbre waveform Tw in detail by using all the fingers of both hands.

Next, the electrical configuration of the synthesizer 1 will be described with reference to FIG. 3. FIG. 3 is a block diagram showing the electrical configuration of the synthesizer 1. The synthesizer 1 includes the CPU 100, a flash ROM 101, a RAM 102, the above-described keyboard 2, setting keys 3, and pedal 4, a sound source 103, and a DSP (Digital Signal Processor) 104, each connected via a bus line 105. A DAC (Digital Analog Converter) 106 is connected to the DSP 104, an amplifier 107 is connected to the DAC 106, and a speaker 108 is connected to the amplifier 107.

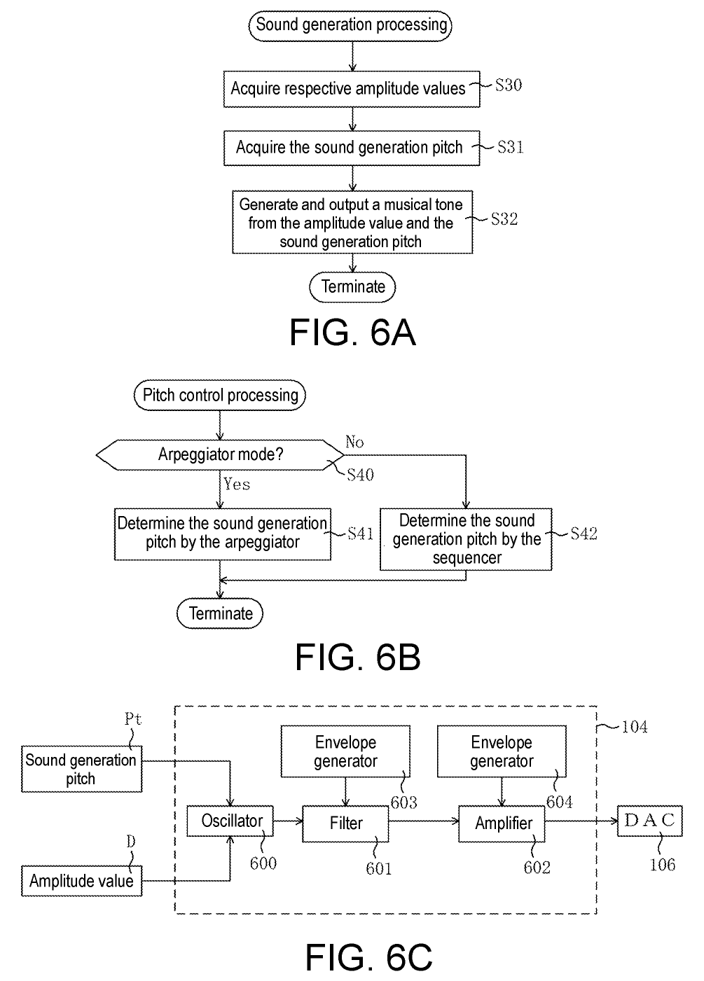

The CPU 100 is an arithmetic device that controls each part connected by the bus line 105. The flash ROM 101 is a rewritable non-volatile memory and includes a control program 101a. In response to the control program 101a being executed by the CPU 100, the main processing of FIG. 5A is executed. The RAM 102 is a memory that stores various work data and flags in a rewritable manner during execution of program such as the control program 101a performed by the CPU 100.

The sound source 103 is a device that outputs waveform data according to performance information input from the CPU 100. The DSP 104 is an arithmetic device for performing arithmetic processing on the waveform data input from the sound source 103. The DAC 106 is a conversion device that converts the waveform data input from the DSP 104 into analog waveform data. The amplifier 107 is an amplification device that amplifies the analog waveform data output from the DAC 106 with a predetermined gain. The speaker 108 is an output device that emits (outputs) the analog waveform data amplified by the amplifier 107 as a musical tone.

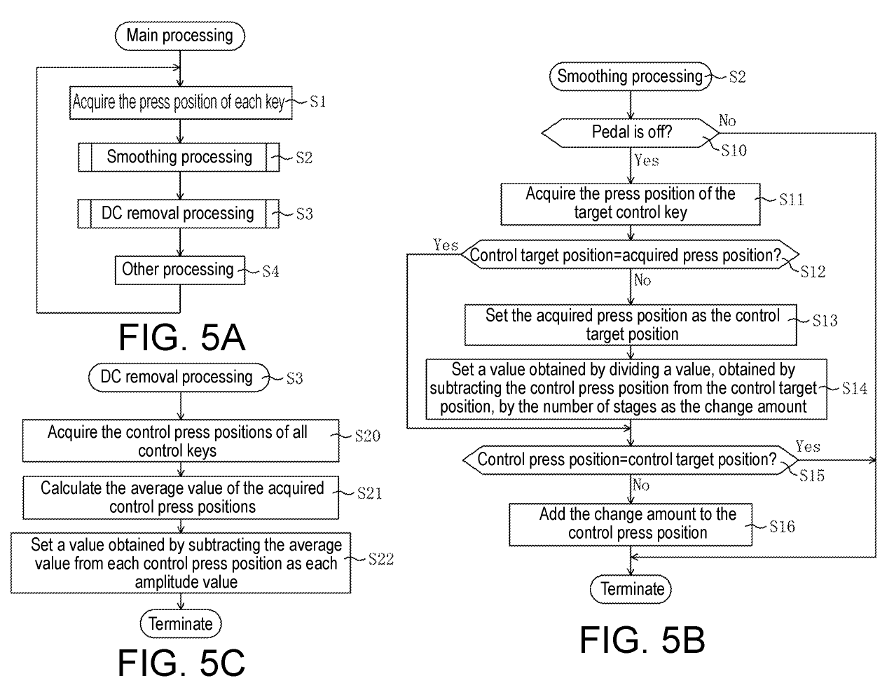

Next, the functions of the synthesizer 1 will be described with reference to FIG. 4. FIG. 4 is a functional block diagram of the synthesizer 1. As shown in FIG. 4, the synthesizer 1 includes a waveform deformation part 500, a musical tone generation part 501, and an output part 502. The waveform deformation part 500 is a part for deforming the timbre waveform Tw of the musical tone being output based on the press positions according to operations on the control keys 2a1 to 2a10, and is realized by the CPU 100 described above in FIG. 3.

The musical tone generation part 501 is a part for generating a musical tone based on the timbre waveform Tw deformed by the waveform deformation part 500 and input pitch information, and is realized by the CPU 100 and the DSP 104 described above. Further, the output part 502 is a part for outputting the musical tone generated by the musical tone generation part 501, and is realized by the CPU 100 and the DSP 104, and the DAC 106, amplifier 107, and speaker 108 described above.

That is, based on the press positions according to operations on the control keys 2a1 to 2a10, the timbre waveform Tw of the musical tone being output is deformed, and a musical tone is generated and output based on the timbre waveform Tw. This makes it possible to change the timbre waveform Tw applied to the musical tone being output, that is, timbre aspects, according to operations of the user H on the control keys 2a1 to 2a10.

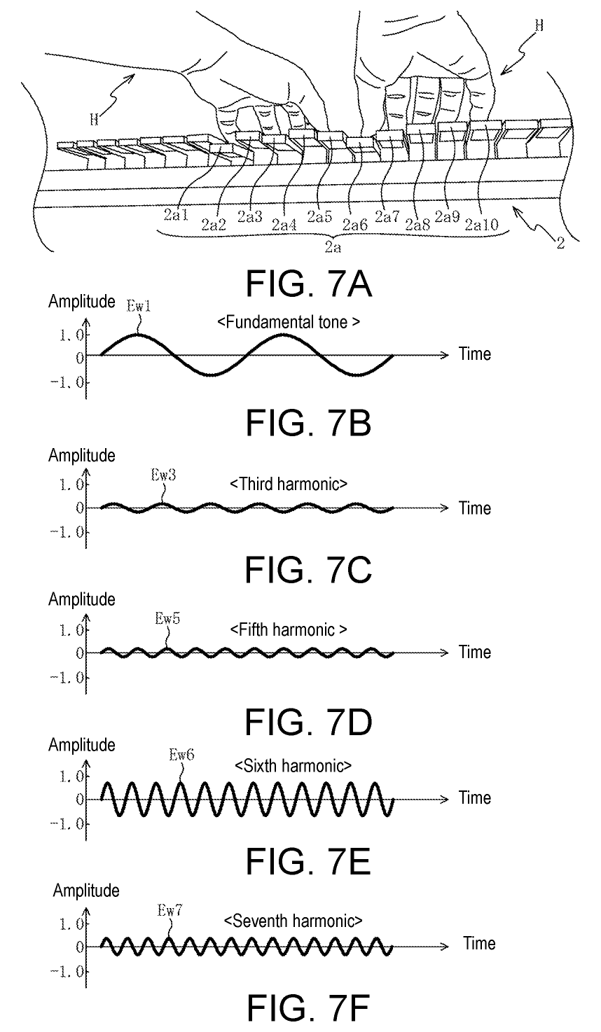

Next, the processing executed by the CPU 100 will be described with reference to FIG. 5A to FIG. 5C and FIG. 6A to FIG. 6C. FIG. 5A is a flowchart of the main processing. The main processing is processing executed in response to power-on of the synthesizer 1. The main processing first acquires the press position of each key 2a provided on the keyboard 2 (S1).

After the processing of S1, smoothing processing (S2) is executed, and thereafter, DC removal processing (S3) is executed. The smoothing processing of S2 is executed for each of the control keys 2a1 to 2a10. After the DC removal processing of S3, other processing (S4) of the synthesizer 1 is executed, and the processing from S1 onward is repeated. Here, the smoothing processing and the DC removal processing, and processing related to these, will be described with reference to FIG. 5B and FIG. 6A to FIG. 6C.

FIG. 5B is a flowchart of the smoothing processing. The smoothing processing is processing that calculates a control press position of the control key 2aX based on the press position of the control key 2aX to be processed. Hereinafter, the control key 2aX to be processed in the smoothing processing is abbreviated as "target control key 2aX," and the same applies to FIG. 6A below.

In addition, the control press position is a press position in control of the control key 2aX used in setting the amplitudes of the corresponding divided periods ΔT1 to ΔT10 in the timbre waveform Tw. The control press position is provided for each target control key 2aX.

The smoothing processing first confirms whether off is input from the pedal 4 (S10). In the processing of S10, in the case of confirming that off is input from the pedal 4 (S10: Yes), the press position of the target control key 2aX is acquired from the press position acquired in the processing of S1 described above (S11).

After the processing of S11, it is confirmed whether a control target position of the target control key 2aX is the press position of the control key 2aX acquired in the processing of S11 (S12). Here, the control target position is provided for each target control key 2aX and is a target position to which the control press position of the target control key 2aX is made to reach. The press position of the target control key 2aX in the smoothing processing up to the previous time is set as the control target position at the time point when the processing of S12 is executed.

In S12, in the case of confirming that the control target position of the target control key 2aX is not the press position of the control key 2aX acquired in the processing of S11 (S12: No), this is a case where the press position has changed with respect to the smoothing processing of the previous time due to pressing of the control key 2aX or the like, so the press position of the control key 2aX acquired in the processing of S11 is set as the control target position of the control key 2aX (S13).

After the processing of S13, a value obtained by subtracting the control press position of the target control key 2aX from the control target position of the target control key 2aX is calculated, and a value obtained by dividing that value by the number of stages is set as a change amount of the target control key 2aX (S14). Here, the number of times the smoothing processing is executed in 10 milliseconds is set to the number of stages. That is, the change amount is a value of one stage (that is, one time of smoothing processing) for making the control press position of the target control key 2aX reach the control target position in 10 milliseconds, and is provided for each target control key 2aX.

The time for making the control press position reach the control target position is not limited to 10 milliseconds, and may be 10 milliseconds or more, 10 milliseconds or less, or a random time. Also, the time for making the control press position reach the control target position may differ depending on the control key 2aX.

In S12, in the case of confirming that the control target position of the target control key 2aX is the press position of the control key 2aX acquired in the processing of S11 (S12: Yes), the processing of S13 and S14 is skipped. After the processing of S12 and S14, it is confirmed whether the control press position of the target control key 2aX has reached the control target position of the target control key 2aX (S15).

In the processing of S15, in the case of confirming that the control press position of the target control key 2aX has not reached the control target position of the target control key 2aX (S15: No), the change amount of the target control key 2aX is added to the control press position of the target control key 2aX (S16). The change amount added in the processing of S16 is either the same as the change amount in the smoothing processing up to the previous time, or the change amount set in the processing of S14 in the current smoothing processing.

On the other hand, in the processing of S15, in the case of confirming that the control press position of the target control key 2aX has reached the control target position of the target control key 2aX (S15: Yes), the processing of S16 is skipped. In the processing of S10, in the case of confirming that on is input from the pedal 4 (S10: No), the processing of S11 to S16 is skipped. After the processing of S10, S15, and S16, the smoothing processing is terminated.

By the above smoothing processing, in the case of the press position, that is, the control target position, being changed due to pressing of the target control key 2aX or the like, the control press position of the target control key 2aX is gradually changed to that control target position over 10 milliseconds. That is to say, the control press position of the target control key 2aX is set as the press position in control in an elapsed stage from the press position of the control key 2aX before change to the press position of the control key 2aX after change.

Furthermore, in the case of the user H stepping on the pedal 4 and on being input from the pedal 4, the processing of S11 to S16 is skipped. Accordingly, in the case of the pedal 4 being stepped on during the time when the press position changes due to pressing of the target control key 2aX or the like, the control press position immediately before the pedal 4 is stepped on is maintained.

Next, the DC removal processing will be described with reference to FIG. 5C. FIG. 5C is a flowchart of the DC removal processing. The DC removal processing is processing for creating an amplitude value with the DC component removed from the control press position set in the smoothing processing.

The DC removal processing first acquires all control press positions of the control keys 2a1 to 2a10 (S20), and calculates an average value of all the acquired control press positions (S21). After the processing of S21, a value obtained by subtracting the average value calculated in the processing of S21 from the control press position of each of the control keys 2a1 to 2a10 is set as the amplitude value of each of the control keys 2a1 to 2a10 (S22). The calculated amplitude values of the control keys 2a1 to 2a10 are respectively used to calculate the amplitudes of the corresponding divided periods ΔT1 to ΔT10 in the sound generation processing (see FIG. 6A) described later.

The amplitude value is calculated by subtracting the average value of the control press positions from the control press position, and in other words, the amplitude value is a value with the "DC component" removed from the control press position. Accordingly, for example, in the case of all of the control keys 2a1 to 2a10 being released, "0" is set to all amplitude values of the control keys 2a1 to 2a10, thereby suppressing a situation where, despite the control keys 2a1 to 2a10 being released, an inappropriate musical tone is generated due to an amplitude other than 0 being set to the timbre waveform Tw. Removing the DC component in the control press position from the amplitude value can also suppress a situation where the DC component is input to the speaker 108, and a voice coil (not shown) inside the speaker 108 generates heat, which damages or deteriorates the voice coil.

Next, the sound generation processing will be described with reference to FIG. 6A. FIG. 6A is a flowchart of the sound generation processing. The sound generation processing is processing for creating the timbre waveform Tw based on the amplitude value set in the DC removal processing, and generating a musical tone to which the created timbre waveform Tw is applied. The sound generation processing is repeatedly executed periodically (for example, every 1 millisecond).

The sound generation processing first acquires the amplitude values of the control keys 2a1 to 2a10 set in the DC removal processing of S3 (S30). After the processing of S30, a sound generation pitch is acquired (S31). The sound generation pitch is a pitch applied to the musical tone generated by the synthesizer 1, and in the present embodiment, is acquired from the arpeggiator or sequencer built into the synthesizer 1. Here, the processing for determining the sound generation pitch acquired in the processing of S31 will be described with reference to FIG. 6B.

FIG. 6B is a flowchart of the pitch control processing. The pitch control processing is processing for determining the above-described sound generation pitch. The pitch control processing is repeatedly executed periodically (for example, every 10 milliseconds). The pitch control processing first confirms whether the operation mode of the synthesizer 1 is an "arpeggiator mode" that determines the sound generation pitch from an arpeggiator (S40).

In the processing of S40, in the case of confirming that the operation mode is the arpeggiator mode (S40: Yes), the pitch output from the arpeggiator built into the synthesizer 1 is determined as the sound generation pitch (S41). The arpeggiator repeatedly outputs an arpeggio based on the pitch set in advance by the user H. In the processing of S41, the pitch at that time point of the arpeggio output from the arpeggiator is set as the sound generation pitch.

On the other hand, in the processing of S40, in the case of not confirming that the operation mode is the arpeggiator mode (S40: No), the pitch output from the sequencer built into the synthesizer 1 is determined as the sound generation pitch (S42). The sequencer repeatedly outputs a series of pitches set in advance by the user H according to the set order. In the processing of S42, the pitch at that time point output from the sequencer is set as the sound generation pitch. After the processing of S41 and S42, the pitch control processing is terminated.

Returning to FIG. 6A, after the processing of S31, a musical tone is generated and output from the amplitude value set in the processing of S30 and the sound generation pitch acquired in the processing of S31 (S32), and the sound generation processing is terminated. Here, the musical tone generation processing by S32 will be described with reference to FIG. 6C.

FIG. 6C is a diagram illustrating the musical tone generation processing. In FIG. 6C, D is the amplitude values of the control keys 2a1 to 2a10 set in the processing of S30 in FIG. 6A, and Pt is the sound generation pitch acquired in the processing of S31 in FIG. 6A.

In the present embodiment, the DSP 104 configures an oscillator 600, a filter 601, an amplifier 602, and envelope generators 603 and 604. The oscillator 600 generates a musical tone based on the input amplitude value D and the sound generation pitch Pt.

In the oscillator 600, first, the timbre waveform Tw described above in FIG. 2B is created by the amplitude value D. Specifically, the amplitude of the divided period ΔT1 of the timbre waveform Tw is set by the amplitude value D of the control key 2a1, the amplitude of the divided period ΔT2 of the timbre waveform Tw is set by the amplitude value D of the control key 2a2, and similarly thereafter, the amplitudes of the divided periods ΔT3 to ΔT10 of the timbre waveform Tw are respectively set by the amplitude values D of the control keys 2a3 to 2a10.

In order that the amplitudes of the divided periods ΔT1 to ΔT10 set by the amplitude values D fall within the range from the minimum value (-1.0) to the maximum value (1.0), for example, the absolute values of the amplitude values D of the control keys 2a1 to 2a10 may be respectively calculated, the maximum value among the calculated absolute values may be acquired, and values obtained by dividing the amplitude values D of the control keys 2a1 to 2a10 by the acquired maximum value may be used for setting the amplitudes of the divided periods ΔT1 to ΔT10 of the timbre waveform Tw.

After the timbre waveform Tw is created in this manner, the oscillator 600 generates waveform data of a musical tone by changing the frequency of the created timbre waveform Tw according to the sound generation pitch Pt.

The filter 601 limits a part of the frequency band in the waveform data created by the oscillator 600. The frequency band limited by the filter 601 is set by the envelope generator 603. The amplifier 602 amplifies a part of the frequency band in the waveform data output from the filter 601. The frequency band amplified by the amplifier 602 is set by the envelope generator 604.

The waveform data output from the amplifier 602 is output to the DAC 106 and converted into analog waveform data, and the analog waveform data is emitted as a musical tone through the amplifier 107 and the speaker 108.

In this way, the control press position is set according to the press position of the control key 2aX, then the amplitude value is calculated based on the control press position, and the timbre waveform Tw is created based on the calculated amplitude value and applied to the musical tone. Accordingly, a timbre with aspects set according to the press position of the control key 2aX is applied to the musical tone for sound generation.

Here, in the case of the press position, that is, the control target position, changing due to pressing of the target control key 2aX or the like, the control press position of the target control key 2aX is gradually changed to the control target position over 10 milliseconds (FIG. 5B: processing of S11 to S16). Accordingly, the amplitudes of the divided periods ΔT1 to ΔT10 corresponding to the target control keys 2aX in the timbre waveform Tw can be gradually changed from a value corresponding to the amplitude before the press position changes to a value corresponding to the amplitude after the press position changes. This can suppress a situation where the timbre waveform Tw changes abruptly, so that a musical tone whose timbre is changed due to a change in the press position of the target control key 2aX can cause little sense of discomfort for the listener.

In addition, since the actual press position of the target control key 2aX includes all fine movements of the fingers of the user H, reflecting all finger movements in the timbre waveform Tw in real time may cause the shape of the timbre waveform Tw to change finely, and the timbre waveform Tw may become unstable. Therefore, by providing the control press position which is a (virtual) press position in control and gradually bringing the control press position close to the control target position which is the actual press position, the change in the shape of the timbre waveform Tw becomes gradual, so it is possible to stabilize the timbre waveform Tw.

Furthermore, in the case of the user H stepping on the pedal 4, the control press position immediately before the pedal 4 is stepped on is maintained (FIG. 5B: processing of S10) to keep the control press position and the control target value unchanged, so the timbre waveform Tw is maintained as it is immediately before the pedal 4 is stepped on. Accordingly, in the case where a timbre desired by the user H can be created through the operation of the user H on the control key 2aX, the timbre is continuously applied to the musical tone in response to the user H stepping on the pedal 4, which can improve the usability of the synthesizer 1 for the user H.

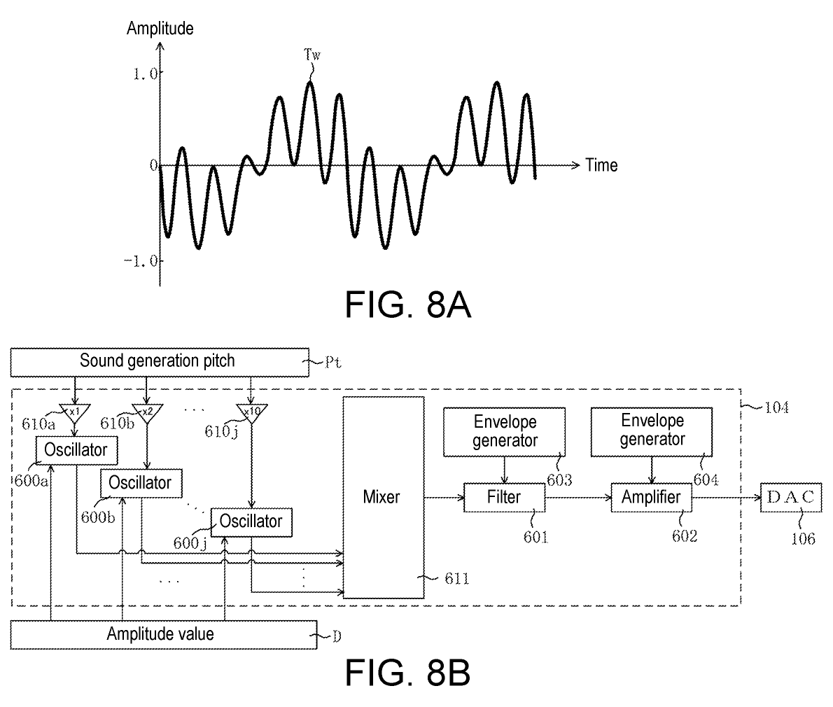

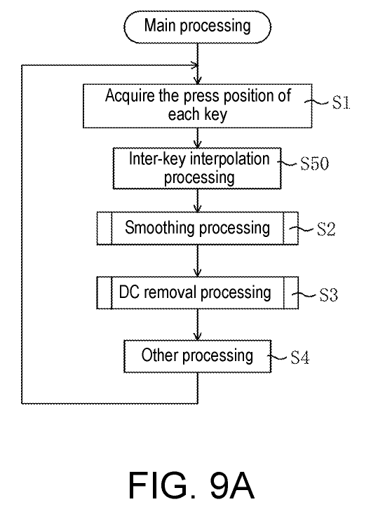

Next, a synthesizer 20 of the second embodiment will be described with reference to FIG. 7A to FIG. 7F and FIG. 8A and FIG. 8B. In the synthesizer 1 of the first embodiment described above, as shown in FIG. 2B, one cycle of the timbre waveform Tw is divided into the divided periods ΔT1 to ΔT10, and the timbre waveform Tw is deformed by setting the amplitudes of the corresponding divided periods ΔT1 to ΔT10 according to the press positions of the control keys 2a1 to 2a10.

In contrast thereto, in the synthesizer 20 of the second embodiment, the amplitudes of the corresponding fundamental tone and each harmonic are set according to the press positions of the control keys 2a1 to 2a10, and the timbre waveform Tw is deformed by synthesizing the waveforms of the fundamental tone and harmonics with the set amplitudes. The same reference numerals are assigned to the same configurations as in the first embodiment described above, and detailed description thereof is omitted.

FIG. 7A is a diagram illustrating the keys 2a used for creating the timbre waveform Tw in the second embodiment. In the second embodiment, the control keys 2a1 to 2a10 are set similarly to the first embodiment, and element waveforms Ew1 to Ew10, which are waveforms representing the fundamental tone or each harmonic, are respectively assigned to the control keys 2a1 to 2a10.

The amplitudes of these element waveforms Ew1 to Ew10 are set according to the press positions of the corresponding control keys 2a1 to 2a10, and the timbre waveform Tw is created (deformed) by adding (synthesizing) the element waveforms Ew1 to Ew10 with the set amplitudes. The element waveforms Ew1 to Ew10 will be described with reference to FIG. 7B to FIG. 7F.

FIG. 7B is a diagram representing the element waveform Ew1 of the fundamental tone based on the press position of the control key 2a1 in the second embodiment, FIG. 7C is a diagram representing the element waveform Ew3 of the third harmonic based on the press position of the control key 2a3 in the second embodiment, FIG. 7D is a diagram representing the element waveform Ew5 of the fifth harmonic based on the press position of the control key 2a5 in the second embodiment, FIG. 7E is a diagram representing the element waveform Ew6 of the sixth harmonic based on the press position of the control key 2a6 in the second embodiment, and FIG. 7F is a diagram representing the element waveform Ew7 of the seventh harmonic based on the press position of the control key 2a7 in the second embodiment.

The element waveform Ew1 (FIG. 7B) of the fundamental tone (for example, 440 Hz) is assigned to the control key 2a1. In the present embodiment, the sound generation pitch Pt is set as the frequency of the fundamental tone. The amplitude of the element waveform Ew1 is set according to the press position of the control key 2a1. In the second embodiment, the waveform of the element waveform Ew1 is composed of a sine wave, but other waveforms such as a rectangular wave and a sawtooth wave may also be used. The amplitude of the element waveform Ew1 is set by default with a minimum value of "-1.0" and a maximum value of "1.0." The lower the press position of the control key 2a1, the larger amplitude is set for the element waveform Ew1, and the higher the press position of the control key 2a1, the smaller amplitude is set for the element waveform Ew1. The above settings of the waveform and amplitude of the element waveform Ew1 are the same for the element waveforms Ew2 to Ew10 described later.

The element waveform Ew2 (not shown) of the second harmonic with respect to the above fundamental tone is assigned to the control key 2a2, and the amplitude of the element waveform Ew2 is set according to the press position of the control key 2a2. The frequency of the element waveform Ew2 is set to twice the frequency of the above-described element waveform Ew1 (fundamental tone, sound generation pitch Pt). Similarly, the frequency of the element waveform Ew3 (FIG. 7C) is set to three times the frequency of the element waveform Ew1, and the frequencies of the element waveforms Ew4 to Ew10 are set to 4 to 10 times the frequency of the element waveform Ew1, respectively.

Further, the element waveforms Ew4 to Ew10 of the fourth to tenth harmonics with respect to the above fundamental tone are respectively assigned to the control keys 2a4 to 2a10, and the amplitudes of the corresponding element waveforms Ew4 to Ew10 are set according to the press positions of the control keys 2a4 to 2a10 (the element waveforms Ew4 and Ew8 to Ew10 are not shown, and the element waveforms Ew5 to Ew7 are shown in FIG. 7D to FIG. 7F, respectively).

For example, in FIG. 7A, the element waveforms Ew1, Ew3, and Ew5 to Ew7 corresponding to the control keys 2a1, 2a3, and 2a5 to 2a7 pressed by the user H are each set with an amplitude larger than 0 according to the lowness of the press position, as shown in FIG. 7B to FIG. 7F. On the other hand, in FIG. 7A, the element waveforms Ew2, Ew4, and Ew8 to Ew10 corresponding to the control keys 2a2, 2a4, and 2a8 to 2a10 released by the user H are each set with an amplitude of 0, although not shown.

Next, the creation of the timbre waveform Tw based on the element waveforms Ew1 to Ew10 with the amplitudes set according to the press positions of the control keys 2a1 to 2a10 will be described with reference to FIG. 8A and FIG. 8B. FIG. 8A is a diagram illustrating the timbre waveform Tw in the second embodiment. In FIG. 8A, the timbre waveform Tw is created by adding the element waveforms Ew1, Ew3, and Ew5 to Ew7 (FIG. 7B to FIG. 7F) corresponding to the control keys 2a1, 2a3, and 2a5 to 2a7 being pressed by the user H.

Similar to the first embodiment, in the second embodiment, the creation of the timbre waveform Tw, the creation of a musical tone using the created timbre waveform Tw, and the generation of the musical tone are performed by the processing of S32 in FIG. 6A, but the processing content differs from the first embodiment. Here, the musical tone generation processing by S32 in the second embodiment will be described with reference to FIG. 8B.

FIG. 8B is a diagram illustrating the musical tone generation processing by S32 in the second embodiment. In the second embodiment, the DSP 104 configures oscillators 600a to 600j, multiplication parts 610a to 610j, a mixer 611, and the filter 601, amplifier 602, and envelope generators 603 and 604 described above in FIG. 6C. The oscillators 600a to 600j respectively generate the element waveforms Ew1 to Ew10 based on the input amplitude value D and the sound generation pitch Pt.

The multiplication parts 610a to 610j are respectively connected to the oscillators 600a to 600j and specify the frequencies of the element waveforms Ew1 to Ew10 to be generated by the oscillators 600a to 600j. Specifically, the multiplication part 610a is connected to the oscillator 600a and specifies the frequency of the element waveform Ew1 generated by the oscillator 600a to be 1 times the frequency of the sound generation pitch Pt (that is, the sound generation pitch Pt as it is). Accordingly, the oscillator 600a generates the element waveform Ew1 having the amplitude value D of the control key 2a1 as the amplitude and the sound generation pitch Pt as the frequency, and outputs the same to the mixer 611 described later.

The multiplication part 610b is connected to the oscillator 600b and specifies the frequency of the element waveform Ew2 generated by the oscillator 600b to be 2 times the frequency of the sound generation pitch Pt (that is, the second harmonic). Accordingly, the oscillator 600b generates the element waveform Ew2 having the amplitude value D of the control key 2a2 as the amplitude and the frequency being 2 times the frequency of the sound generation pitch Pt, and outputs the same to the mixer 611.

Similarly, the multiplication parts 610c to 610j are respectively connected to the oscillators 600c to 600j and specify the frequencies of the element waveforms Ew3 to Ew10 generated by the oscillators 600c to 600j respectively to be 3 to 10 times the frequency of the sound generation pitch Pt (that is, the third to tenth harmonics). Accordingly, the oscillators 600c to 600j generate the element waveforms Ew3 to Ew10 having the amplitude values D of the control keys 2a3 to 2a10 as the amplitudes and the frequencies being 3 to 10 times the frequency of the sound generation pitch Pt, and output the same to the mixer 611.

The mixer 611 creates the timbre waveform Tw by adding (synthesizing, mixing) the element waveforms Ew1 to Ew10 input from the oscillators 600a to 600j, and creates waveform data based on the timbre waveform Tw.

In the mixer 611, the absolute values of the amplitudes in the waveform resulting from adding the element waveforms Ew1 to Ew10 may be calculated so that the amplitude of the created timbre waveform Tw falls within the range from the minimum value (-1.0) to the maximum value (1.0) of the amplitude of the timbre waveform Tw, the maximum value among the calculated absolute values may be acquired, and the waveform obtained by dividing the amplitude in the waveform resulting from adding the element waveforms Ew1 to Ew10 by the acquired maximum value may be used as the timbre waveform Tw.

The waveform data created by the mixer 611 is input to the above-described filter 601, and is further emitted as a musical tone through the amplifier 602, the DAC 106, the amplifier 107, and the speaker 108.

Thus, in the synthesizer 20 of the second embodiment, the amplitudes of the element waveforms Ew1 to Ew10 of the fundamental tone and each harmonic based on the sound generation pitch Pt are set according to the press positions of the control keys 2a1 to 2a10, and the timbre waveform Tw is created (deformed) by adding the set element waveforms Ew1 to Ew10. That is, since the amplitudes of the fundamental tone and each harmonic included in the timbre waveform Tw have magnitudes according to the press positions of the corresponding control keys 2a1 to 2a10, the user H can intuitively grasp the components of the fundamental tone and each harmonic in the timbre waveform Tw while changing the fundamental tone and each harmonic included in the timbre waveform Tw in detail. This makes it possible to easily and precisely change the harmonious timbre aspects of the fundamental tone and each harmonic.

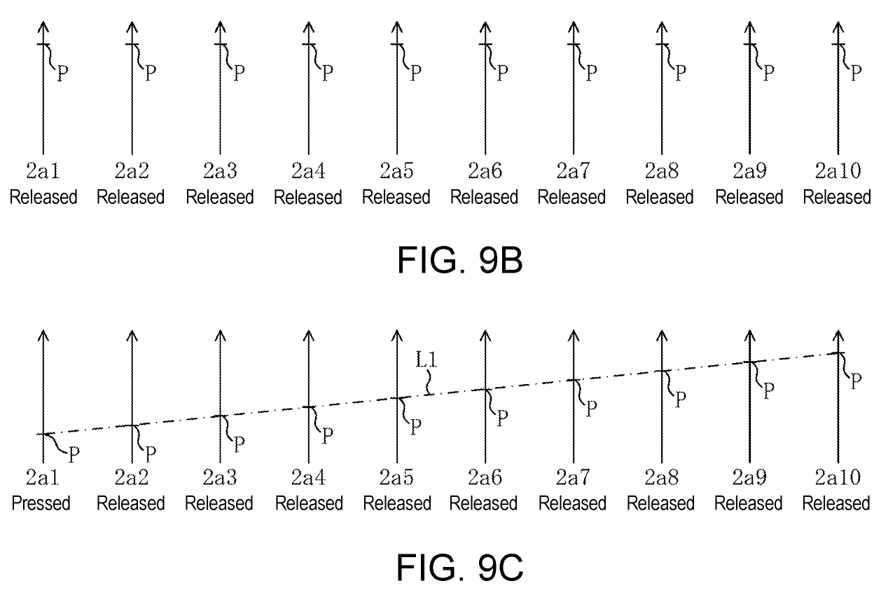

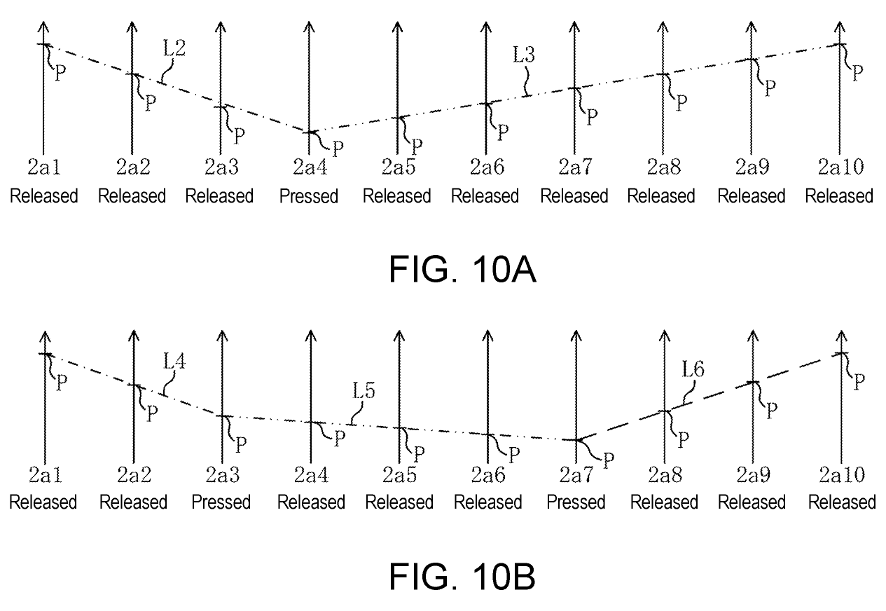

Next, a synthesizer 30 of the third embodiment will be described with reference to FIG. 9A to FIG. 9C and FIG. 10A and FIG. 10B. In the synthesizers 1 and 20 of the first and second embodiments described above, the press positions obtained from the control keys 2a1 to 2a10 are directly used to calculate amplitude values, which are used to create the timbre waveform Tw.

In contrast thereto, in the synthesizer 30 of the third embodiment, interpolated press positions P interpolated based on the press positions of other control keys 2a1 to 2a10 are set as the press positions of the control keys 2a1 to 2a10, and amplitude values are calculated using the set interpolated press positions P, which are then used to create the timbre waveform Tw. The same reference numerals are assigned to the same configurations as in the first and second embodiments described above, and detailed descriptions thereof are omitted.

FIG. 9A is a flowchart of the main processing of the third embodiment. The main processing of the third embodiment executes inter-key interpolation processing (S50) after the processing of S1, and then executes the smoothing processing of S2 and subsequent processing. The inter-key interpolation processing is processing that calculates the interpolated press positions P, which are positions interpolated by the press positions of other control keys 2a1 to 2a10, as the press positions of the control keys 2a1 to 2a10. The interpolated press positions P of the control keys 2a1 to 2a10 calculated in the inter-key interpolation processing are used as the press positions of the control keys 2a1 to 2a10 in the smoothing processing of S2. Here, the details of the inter-key interpolation processing of S50 will be described with reference to FIG. 9B, FIG. 9C, FIG. 10A, and FIG. 10B.

FIG. 9B is a diagram representing the interpolated press position P of each of the control keys 2a1 to 2a10 in the case of all the control keys 2a1 to 2a10 being released in the third embodiment. In FIG. 9B, FIG. 9C, FIG. 10A, and FIG. 10B, the control keys 2a1 to 2a10 are shown schematically, and like the actual control keys 2a1 to 2a10, the schematic control keys 2a1 to 2a10 are also arranged at equal intervals in the left-right direction. The position of each of the control keys 2a1 to 2a10 in the up-down direction in FIG. 9B, FIG. 9C, FIG. 10A, and FIG. 10B represents the press position or the interpolated press position P.

In the third embodiment, as shown in FIG. 9B, in the case of all the control keys 2a1 to 2a10 being released, in the processing of S50, the press positions at which the respective control keys 2a1 to 2a10 are released are set as the interpolated press positions P of the control keys 2a1 to 2a10.

Next, the press positions of the control keys 2a1 to 2a10 in the case of one of the control keys 2a1 to 2a10 being pressed will be described. FIG. 9C is a diagram representing the interpolated press positions P of the control keys 2a1 to 2a10 in the case of one of the control keys 2a1 to 2a10 (control key 2a1) being pressed in the third embodiment, and FIG. 10A is a diagram representing the interpolated press positions P of the control keys 2a1 to 2a10 in the case of another one of the control keys 2a1 to 2a10 (control key 2a4) being pressed in the third embodiment.

In the processing of S50, in the case where there is one pressed control key among the control keys 2a1 to 2a10, the interpolated press positions P of the control keys 2a1 to 2a10 are set based on the press position of the one pressed control key among the control keys 2a1 to 2a10, the press position of the control key 2a1 positioned at the leftmost side, and the press position of the control key 2a10 positioned at the rightmost side.

In FIG. 9C, only the control key 2a1 is pressed. In this case, since the pressed control key 2a1 is positioned at the leftmost side, the interpolated press positions P of the control keys 2a1 to 2a10 are set from the press position of the control key 2a1 and the press position of the control key 2a10 positioned at the rightmost side. In this case, the control key 2a1 serves as the "first target operator" and the control key 2a10 serves as the "second target operator."

Specifically, first, the press position of the pressed control key 2a1 and the press position of the rightmost control key 2a10 are connected, and a straight line L1 that crosses the control keys 2a2 to 2a9 therebetween is calculated. The press position of the control key 2a1, which is the starting point of the calculated straight line L1, is set as the interpolated press position P of the control key 2a1, and the press position of the control key 2a10, which is the end point of the straight line L1, is set as the interpolated press position P of the control key 2a10.

The interpolated press positions P of the control keys 2a2 to 2a9 positioned between the control key 2a1 and the control key 2a10 are respectively set at the positions of the intersections of the straight line L1 and the control keys 2a2 to 2a9. In this way, the interpolated press positions P of the control keys 2a1 to 2a10 in the case where only the control key 2a1 is pressed are set. The interpolated press positions P of the control keys 2a1 to 2a10 in the case where only the control key 2a10 is pressed are also set in the same manner as in the case of FIG. 9C.

Next, the setting of the interpolated press positions P of the control keys 2a1 to 2a10 in the case where only the control key 2a4 is pressed will be described with reference to FIG. 10A. In the case where only the control key 2a4 is pressed, first, the press position of the control key 2a1 positioned at the leftmost side and the press position of the control key 2a4 are connected, and a straight line L2 that crosses the control keys 2a2 and 2a3 therebetween is calculated. In this case, the control key 2a1 serves as the "first target operator" and the control key 2a4 serves as the "second target operator."

The press position of the control key 2a1, which is the starting point of the calculated straight line L2, is set as the interpolated press position P of the control key 2a1, and the press position of the control key 2a4, which is the end point of the straight line L2, is set as the interpolated press position P of the control key 2a4. The interpolated press positions P of the control keys 2a2 and 2a3 positioned therebetween are respectively set at the positions of the intersections of the straight line L2 and the control keys 2a2 and 2a3.

Furthermore, the press position of the control key 2a4 and the press position of the control key 2a10 positioned at the rightmost side are connected, and a straight line L3 that crosses the control keys 2a5 to 2a9 therebetween is calculated. In this case, the control key 2a4 serves as the "first target operator" and the control key 2a10 serves as the "second target operator." The press position of the control key 2a10, which is the end point of the calculated straight line L3, is set as the interpolated press position P of the control key 2a10. Also, the interpolated press positions P of the control keys 2a5 to 2a9 positioned therebetween are respectively set at the positions of the intersections of the straight line L3 and the control keys 2a5 to 2a9.

In this way, the interpolated press positions P of the control keys 2a1 to 2a10 in the case where only the control key 2a4 is pressed are set. The interpolated press positions P of the control keys 2a1 to 2a10 in the case where only the control keys 2a2, 2a3, and 2a5 to 2a9 are pressed are also set in the same manner as in the case of FIG. 10A.

Next, the interpolated press positions P in the case where two of the control keys 2a1 to 2a10 are pressed will be described with reference to FIG. 10B. FIG. 10B is a diagram representing the interpolated press positions P of the control keys 2a1 to 2a10 in the case of two (control keys 2a3 and 2a7) of the control keys 2a1 to 2a10 being pressed in the third embodiment.

In the case where the two control keys 2a3 and 2a7 are pressed, first, the press position of the control key 2a1 positioned at the leftmost side and the press position of the pressed control key 2a3 are connected, and a straight line L4 that crosses the control key 2a2 therebetween is calculated. In this case, the control key 2a1 serves as the "first target operator" and the control key 2a3 serves as the "second target operator."

The press position of the control key 2a1, which is the starting point of the straight line L4, is set as the interpolated press position P of the control key 2a1, and the press position of the control key 2a3, which is the end point of the straight line L4, is set as the interpolated press position P of the control key 2a3. The interpolated press position P of the control key 2a2 positioned therebetween is set at the position of the intersection of the straight line L4 and the control key 2a2.

Next, the press position of the pressed control key 2a3 and the press position of the similarly pressed control key 2a7 are connected, and a straight line L5 that crosses the control keys 2a4 to 2a6 therebetween is calculated. In this case, the control key 2a3 serves as the "first target operator" and the control key 2a7 serves as the "second target operator." The press position of the control key 2a7, which is the end point of the straight line L5, is set as the interpolated press position P of the control key 2a7. The interpolated press positions P of the control keys 2a4 to 2a6 positioned between the control key 2a3 and the control key 2a7 are respectively set at the positions of the intersections of the straight line L5 and the control keys 2a4 to 2a6.

Furthermore, the press position of the pressed control key 2a7 and the press position of the rightmost control key 2a10 are connected, and a straight line L6 that crosses the control keys 2a8 and 2a9 therebetween is calculated. In this case, the control key 2a7 serves as the "first target operator" and the control key 2a10 serves as the "second target operator." The press position of the control key 2a10, which is the end point of the straight line L6, is set as the interpolated press position P of the control key 2a10. The interpolated press positions P of the control keys 2a8 and 2a9 positioned between the control key 2a7 and the control key 2a10 are respectively set at the positions of the intersections of the straight line L6 and the control keys 2a8 and 2a9.

In this way, the interpolated press positions P of the control keys 2a1 to 2a10 in the case of the control keys 2a3 and 2a7 being pressed are set. The interpolated press positions P of the control keys 2a1 to 2a10 are similarly set in the case of two control keys other than the control keys 2a3 and 2a7 among the control keys 2a1 to 2a10 being pressed. In addition, the interpolated press positions P of the control keys 2a1 to 2a10 in the case of three or more of the control keys 2a1 to 2a10 being pressed are set by the above-described method.

Thus, in the synthesizer 30 of the third embodiment, in the processing of S50, a straight line connecting the press positions of the pressed control keys 2a1 to 2a10, the press position of the control key 2a1, and the press position of the control key 2a10 is calculated. The intersections of the calculated straight line and the positions of the control keys 2a1 to 2a10 are respectively set as the interpolated press positions P of the control keys 2a1 to 2a10. The interpolated press positions P set in this way are used as the press positions of the control keys 2a1 to 2a10 in the smoothing processing of S2.

For example, as shown in FIG. 10B, in the case of the pressed control key 2a7 and the released control keys 2a8 to 2a10 being adjacent to each other, the actual press positions of the released control keys 2a8 to 2a10 are high while the control key 2a7 is low. That is to say, in the series of control keys 2a7 to 2a10, only the press position of the control key 2a7 drops sharply.

In the case of creating the timbre waveform Tw (see FIG. 2B) of the first embodiment particularly based on such press positions, the timbre waveform Tw has a distorted shape in which the amplitude of the divided period ΔT7 drops sharply compared to the amplitudes of the divided periods ΔT8 to ΔT10. A musical tone generated using such a distorted timbre waveform Tw may cause the listener to experience a sense of discomfort auditorily.

Therefore, by setting the interpolated press positions P of the control keys 2a7 to 2a10 based on the straight line L6 connecting the press position of the control key 2a7 and the press position of the control key 2a10, the interpolated press positions P of the control keys 2a7 to 2a10 can be increased stepwise from the lowest control key 2a7 to the highest control key 2a10. This suppresses the distortion of the shape of the timbre waveform Tw, making it possible to reduce a sense of discomfort for the listener for the musical tone generated using such a timbre waveform Tw.

Although the disclosure has been described based on the above embodiments, it can be easily inferred that various improvements and modifications are possible.

Although the above embodiments respectively illustrate the synthesizers 1, 20, and 30, a synthesizer may be configured by appropriately combining the functions of the synthesizers 1, 20, and 30. For example, the synthesizer 1 of the first embodiment and the synthesizer of the second embodiment may be combined.

In this case, among the keys 2a provided on the keyboard 2, the control keys 2a1 to 2a10 for creating the timbre waveform Tw of the first embodiment and the control keys 2a1 to 2a10 for creating the timbre waveform Tw of the second embodiment are assigned separately. In the case of the control keys 2a1 to 2a10 for creating the timbre waveform Tw of the first embodiment being pressed, the timbre waveform Tw of the first embodiment is created, and in the case of the control keys 2a1 to 2a10 for creating the timbre waveform Tw of the second embodiment being pressed, the timbre waveform Tw of the second embodiment is created. At this time, in the case of the control keys 2a1 to 2a10 for creating the timbre waveform Tw of the first embodiment and the control keys 2a1 to 2a10 for creating the timbre waveform Tw of the second embodiment being pressed simultaneously, a mixture of the timbre waveforms Tw of the first and second embodiments may be created as the timbre waveform Tw.

In the first and second embodiments, the press positions of the control keys 2a1 to 2a10 are directly used for calculating amplitude values, and in the third embodiment, the interpolated press positions P of the control keys 2a1 to 2a10 are directly used for calculating amplitude values, but the disclosure is not limited thereto. An output function with the press position or the interpolated press position P as input may be provided for each of the control keys 2a1 to 2a10, and output values resulting from inputting the press positions or the interpolated press positions P of the control keys 2a1 to 2a10 into the respective output functions may be used for calculating amplitude values. Linear functions, quadratic functions, exponential functions, logarithmic functions, and trigonometric functions are exemplified as the output function, but other functions may also be used. Further, the output function may be configured by a single function or may be configured by combining multiple functions.

By providing an output function with the press position or the interpolated press position P as input for each of the control keys 2a1 to 2a10, and calculating the amplitude value using the output value of the output function in this manner, for example, even in the case of two press positions or interpolated press positions P among the control keys 2a1 to 2a10 being the same, the output values differ as long as these output functions are different. Thus, it is possible to change the shape of the timbre waveform Tw in various ways even with the same press positions or interpolated press positions P of the control keys 2a1 to 2a10, making it easy to make the musical tone based on the timbre waveform Tw rich in variation.

In the above embodiments, the operators for calculating amplitude values are the control keys 2a1 to 2a10 configured by ten consecutive white keys among the keys 2a provided on the keyboard 2, but the disclosure is not limited thereto. The operators for calculating amplitude values may be configured by consecutive black keys among the keys 2a, or may be configured by consecutive white keys and black keys. Further, the operators for calculating amplitude values may be configured by other operators such as the setting keys 3. In addition, the number of operators for calculating amplitude values is not limited to ten, like the control keys 2a1 to 2a10, and may be ten or more or may be ten or fewer.

In the above embodiments, amplitude values are calculated based on the press positions of the control keys 2a1 to 2a10, but the disclosure is not limited thereto. For example, capacitive type or pressure-sensitive type touch sensors may be provided on respective surfaces of the control keys 2a1 to 2a10, and amplitude values of the control keys 2a1 to 2a10 may be calculated according to positions in the up-down direction or the left-right direction in a top view of the control keys 2a1 to 2a10 detected by the touch sensors of the control keys 2a1 to 2a10.

For example, in the case of setting amplitude values according to positions in the up-down direction in a top view of the control keys 2a1 to 2a10, a larger amplitude value may be set for a higher position detected by the touch sensor, and a smaller amplitude value may be set for a lower position detected by the touch sensor. Further, in the case of setting amplitude values according to positions in the left-right direction in a top view of the control keys 2a1 to 2a10, a larger amplitude value may be set for a rightward position detected by the touch sensor, and a smaller amplitude value may be set for a leftward position detected by the touch sensor.

Furthermore, the timbre waveform Tw may be created based on a combination of the press positions of the control keys 2a1 to 2a10 and the positions in the up-down direction or the left-right direction in a top view of the control keys 2a1 to 2a10. For example, in the case of creating the timbre waveform Tw of the second embodiment, the configuration may be made so that the shapes (sine wave, rectangular wave, sawtooth wave, etc.) of the element waveforms Ew1 to Ew10 can be selected according to positions in the left-right direction in a top view detected by the touch sensors of the control keys 2a1 to 2a10, and amplitudes of the element waveforms Ew1 to Ew10 in the selected shapes may be set according to the press positions of the control keys 2a1 to 2a10.

Thereby, the shapes of waveforms of the element waveforms Ew1 to Ew10 can be set respectively for the control keys 2a1 to2a10 through operations of the user H in the left-right direction in a top view on the control keys 2a1 to 2a10, and further, amplitudes of the element waveforms Ew1 to Ew10 can be changed by the press positions of the control keys 2a1 to 2a10, so that the timbre applied to the musical tone being generated can be changed more diversely.

In the above embodiments, in the case of the control target position changing, the control press position of the target control key 2aX is gradually changed to that control target position over 10 milliseconds by the smoothing processing of FIG. 5B, but the disclosure is not limited thereto. For example, in the case of the control target position changing, the control press position of the target control key 2aX may be immediately changed to the control target position.

In the above embodiments, the second operator is the pedal 4, and in the case of the pedal 4 being stepped on, the timbre waveform Tw immediately before the pedal 4 is stepped on is maintained, but the disclosure is not limited thereto. The second operator may be configured by the setting keys 3, may be configured by keys 2a other than the control keys 2a1 to 2a10, or may be configured by other operators.

In the above embodiments, the sound generation pitch is acquired from the arpeggiator or sequencer in the pitch control processing of FIG. 6B, but the disclosure is not limited thereto. For example, the sound generation pitch may be acquired based on pressing on keys 2a different from the control keys 2a1 to 2a10 among the keys 2a of the keyboard 2. In this case, it is preferable to set the control keys 2a1 to 2a10 to keys 2a positioned on the left side of the keyboard 2 that are easy to play with the left hand of the user H, and to set the keys 2a for acquiring the sound generation pitch to keys 2a positioned on the right side of the keyboard 2 that are easy to play with the right hand of the user H.

Accordingly, the "pitch of the musical tone" can be input by operating the keys 2a with the right hand of the user H, and by operating the control keys 2a1 to 2a10 with the left hand of the user H, the timbre of the timbre waveform Tw based on that operation can be input as the "timbre of the musical tone." Furthermore, in this case, it is preferable to set the control keys to five or fewer, such as control keys 2a1 to 2a5, to match the number of fingers of the left hand of the user H.

Alternatively, the sound generation pitch may be acquired from another computer connected to the synthesizers 1, 20, and 30 via a network such as the Internet.

In the first embodiment, the range for deforming the shape of the timbre waveform Tw based on the press positions of the control keys 2a1 to 2a10 is set to one cycle of the timbre waveform Tw, but the disclosure is not limited thereto. The range for deforming the shape of the timbre waveform Tw based on the press positions of the control keys 2a1 to 2a10 may be a period of one cycle or more of the timbre waveform Tw, or may be a period of one cycle or less.

In the first embodiment, the divided periods ΔT1 to ΔT10 are each set to the same length, but the disclosure is not limited thereto, and the lengths of the divided periods ΔT1 to ΔT10 may be different from each other. For example, the divided period ΔT1 may be set longer than the divided period ΔT2, or the divided period ΔT7 may be set longer than the divided period ΔT6. Besides, the lengths of the divided periods ΔT1 to ΔT10 may each be set randomly.

In the first embodiment, the amplitudes in the divided periods ΔT1 to ΔT10 are set to larger values as the press positions of the corresponding control keys 2a1 to 2a10 become higher, and are set to smaller values as the press positions of the corresponding control keys 2a1 to 2a10 become lower, but the disclosure is not limited thereto. For example, smaller values may be set for the amplitudes of the corresponding divided periods ΔT1 to ΔT10 as the press positions of the control keys 2a1 to 2a10 become higher, and larger values may be set for the amplitudes of the corresponding divided periods ΔT1 to ΔT10 as the press positions of the control keys 2a1 to 2a10 become lower.

In the first embodiment, the amplitude set in each of the divided periods ΔT1 to ΔT10 is configured to continue during each of the divided periods ΔT1 to ΔT10, but the disclosure is not limited thereto, and the amplitude during each of the divided periods ΔT1 to ΔT10 may be changed based on the set amplitude. For example, the value of amplitude set in each of the divided periods ΔT1 to ΔT10 may be set at a predetermined time point of each of the divided periods ΔT1 to ΔT10 (for example, at the start time point of each of the divided periods ΔT1 to ΔT10), and the timbre waveform Tw may be formed by connecting the predetermined time points of adjacent divided periods ΔT1 to ΔT10. In this case, the predetermined time points of adjacent divided periods ΔT1 to ΔT10 may be connected linearly (in a straight line) or non-linearly (for example, in a curved line).

In the third embodiment, the schematic control keys 2a1 to 2a10 are arranged at equal intervals in the left-right direction, but the disclosure is not limited thereto. The intervals of the schematic control keys 2a1 to 2a10 in the left-right direction may be different from each other. For example, the interval between the control key 2a1 and the control key 2a2 may be larger than the interval between the control key 2a2 and the control key 2a3.

In the above embodiments, the control program 101a is stored in the flash ROM 101 of the synthesizers 1, 20, and 30 and operated on the synthesizers 1, 20, and 30, but the disclosure is not limited thereto. The control program 101a may be operated on other electronic musical instruments such as an electronic piano. Also, the control program 101a may be operated on other computers or electronic devices such as PCs (personal computers), mobile phones, smartphones, and tablet terminals. In this case, a keyboard device having the same configuration as the keyboard 2 may be connected to the PC, mobile phone, or the like.

What is claimed is:

1. An electronic device, comprising a plurality of operators and outputting a musical tone, the electronic device comprising:
a hardware processor configured to:
deform a timbre waveform, which is a basic waveform representing a timbre of the musical tone being output, based on a setting value according to an operation on each of the operators;
generate the musical tone based on the deformed timbre waveform and pitch information that is input; and
output the generated musical tone.

2. The electronic device according to claim 1, wherein:
divided periods are set by dividing a predetermined period in the timbre waveform by the number of the operators,
the operators are respectively assigned to the divided periods, and
the hardware processor respectively sets amplitudes in the corresponding divided periods based on setting values of the operators, and deforms the timbre waveform based on the set amplitudes in the divided periods.

3. The electronic device according to claim 2, wherein:
the predetermined period is one cycle in the timbre waveform.

4. The electronic device according to claim 1, wherein:
the operators are assigned to a fundamental tone and harmonics, and
the hardware processor creates element waveforms, which are waveforms of the fundamental tone and the harmonics having amplitudes based on the setting values of the operators, respectively for the operators, and deforms the timbre waveform based on the created element waveforms.

5. The electronic device according to claim 1, wherein:
an output function, which is a function with the setting value of the operator as input, is provided for each of the operators, and
the hardware processor deforms the timbre waveform based on an output value resulting from inputting the setting value of the operator into the corresponding output function.

6. The electronic device according to claim 1, comprising:
a second operator different from the operators, wherein:
the hardware processor maintains the timbre waveform at a time point when the second operator is operated in a case where a setting value of the second operator becomes a predetermined value.

7. The electronic device according to claim 1, wherein:
the hardware processor sets a setting value in control in an elapsed stage from the setting value before change to the setting value after change in a case where the setting value of the operator is changed, and
deforms the timbre waveform based on the set setting value in control.

8. The electronic device according to claim 1, wherein:
the operators are provided in a row,
the hardware processor interpolates, according to a difference between a setting value of a first target operator, which is one of the operators, and a setting value of a second target operator, which is a different operator from the first target operator, setting values of other operators positioned between the first target operator and the second target operator, and
deforms the timbre waveform based on the setting value of the first target operator and the setting value of the second target operator, and the interpolated setting values of the other operators.

9. The electronic device according to claim 1, wherein:
the electronic device is an electronic musical instrument,
the operators comprise keys of a keyboard included in the electronic musical instrument, and
the hardware processor deforms the timbre waveform based on a press position of each of the keys.

10. The electronic device according to claim 9, wherein:
the operators comprise ten white keys provided consecutively on the keyboard.

11. A timbre change method, executed by an electronic device comprising a plurality of operators, the timbre change method comprising:
deforming a timbre waveform, which is a basic waveform representing a timbre of a musical tone being output, based on a setting value according to an operation on each of the operators;
generating the musical tone based on the deformed timbre waveform and pitch information that is input; and
outputting the generated musical tone.

12. The timbre change method according to claim 11, wherein:
divided periods are set by dividing a predetermined period in the timbre waveform by the number of the operators,
the operators are respectively assigned to the divided periods, and
the timbre change method comprises respectively setting amplitudes in the corresponding divided periods based on setting values of the operators, and deforming the timbre waveform based on the set amplitudes in the divided periods.

13. The timbre change method according to claim 11, wherein:
the operators are assigned to a fundamental tone and harmonics, and
the timbre change method comprises creating element waveforms, which are waveforms of the fundamental tone and the harmonics having amplitudes based on the setting values of the operators, respectively for the operators, and deforming the timbre waveform based on the created element waveforms.

14. The timbre change method according to claim 11, further comprising:
setting a setting value in control in an elapsed stage from the setting value before change to the setting value after change in a case where the setting value of the operator is changed, and
deforming the timbre waveform based on the set setting value in control.

15. The timbre change method according to claim 11, wherein:
the operators are provided in a row, and
the timbre change method comprises interpolating, according to a difference between a setting value of a first target operator, which is one of the operators, and a setting value of a second target operator, which is a different operator from the first target operator, setting values of other operators positioned between the first target operator and the second target operator, and
deforming the timbre waveform based on the setting value of the first target operator and the setting value of the second target operator, and the interpolated setting values of the other operators.

16. A non-transitory computer-readable recording medium, recording a timbre change program, causing a computer comprising a plurality of operators to execute processing for changing a timbre of a musical tone being output, the timbre change program causing the computer to execute:
deforming a timbre waveform, which is a basic waveform representing the timbre of the musical tone being output, based on a setting value according to an operation on each of the operators;
generating the musical tone based on the deformed timbre waveform and pitch information that is input; and
outputting the generated musical tone.

17. The non-transitory computer-readable recording medium according to claim 16, wherein:
divided periods are set by dividing a predetermined period in the timbre waveform by the number of the operators,
the operators are respectively assigned to the divided periods, and
the timbre change program causes the computer to respectively set amplitudes in the corresponding divided periods based on setting values of the operators, and deform the timbre waveform based on the set amplitudes in the divided periods.

18. The non-transitory computer-readable recording medium according to claim 16, wherein:
the operators are assigned to a fundamental tone and harmonics, and
the timbre change program causes the computer to create element waveforms, which are waveforms of the fundamental tone and the harmonics having amplitudes based on the setting values of the operators, respectively for the operators, and deform the timbre waveform based on the created element waveforms.

19. The non-transitory computer-readable recording medium according to claim 16, wherein:
the timbre change program causes the computer to set a setting value in control in an elapsed stage from the setting value before change to the setting value after change in a case where the setting value of the operator is changed, and
deform the timbre waveform based on the set setting value in control.

20. The non-transitory computer-readable recording medium according to claim 16, wherein:
the operators are provided in a row, and
the timbre change program causes the computer to interpolate, according to a difference between a setting value of a first target operator, which is one of the operators, and a setting value of a second target operator, which is a different operator from the first target operator, setting values of other operators positioned between the first target operator and the second target operator, and
deform the timbre waveform based on the setting value of the first target operator and the setting value of the second target operator, and the interpolated setting values of the other operators.
